(19) United States
(12) Patent Application Publication
(10) Pub. No.: US 2006/0161520 A1
(43) Pub. Date: Jul. 20, 2006

(54) System and method for generating alternative search terms

(75) Inventors: Brett D. Brewer, Sammamish, WA (US); Eric B. Watson, Redmond, WA (US); Eric D. Brill, Redmond, WA (US); James Dai, Redmond, WA (US); Oliver Hurst-Hiller, Seattle, WA (US); Robert J. Ragno, Kirkland, WA (US); Silviu-Petru Cucerzan, Redmond, WA (US)

Correspondence Address: SHOOK, HARDY & BACON L.L.P.;(c/o MICROSOFT CORPORATION), 2555 GRAND BOULEVARD, KANSAS CITY, MO, 64108-2613, US

(73) Assignee: Microsoft Corporation, Redmond, WA (US)

(21) Appl. No.: 11/034,777

(22) Filed: Jan. 14, 2005

(51) Int. Cl. G06F 17/30

(52) U.S. Cl. 707/3

(57) ABSTRACT

A system and related techniques accepts user search or query terms over of the Internet or other network or connection. In addition to presenting regularly generated search results, according to embodiments of the invention the search engine and related logic may examine the search string for suggested refinements or improvements to the search terms, to attempt to derive improved results or results closer to the user's search intent. According to embodiments of the invention in one regard, the alternative search logic may attempt to extract related or more meaningful search terms from sources including past usage patterns by users, and other data. That alternative search logic may thus examine the user's search terms to determine a substring match to prior searches, for instance stored by the search host for all users. In embodiments, the alternative search logic may likewise present user search extensions or refinement paths selected by prior users running the same search, as an indicator of likely content or source relevance. In further embodiments, the alternative search logic may perform a reverse query lookup to trace queries which resulted in the same Web site or other hit, as the present search and present those other queries as possible alternatives for the user to pursue. These and other search refinements may be performed, taking advantage of usage patterns and other information to improve search quality beyond straightforward spelling-type correction.

### CROSS-REFERENCE TO RELATED APPLICATION

Not applicable.

### STATEMENT REGARDING FEDERALLY SPONSORED RESEARCH OR DEVELOPMENT

Not applicable.

### FIELD OF THE INVENTION

The invention relates to the field of computerized search, and more particularly to a system and method capable of parsing a user's inputted search terms and automatically generating a suggested set of search term refinements based on the user's input, usage patterns and other data.

### BACKGROUND OF THE INVENTION

Computerized search technology on the Internet and other networks has grown and developed in power and effectiveness in recent years. The ability of various search services to crawl the Internet or other networks, build indices of key words and other information from Web sites and update those searchable data stores has led to increased search quality and breadth for a wide range of content.

Search users have however often been presented with Web search sites which offer a fairly rigid input interface, in the sense that the user must precisely type in a word or set of words or other search inputs or terms which they wish to locate in Web or other sources. When the search input does not literally match keywords stored in the search engine's search indices, potentially relevant documents may be missed and not presented to that user. Some Internet search services, as illustrated for instance in FIG. 1, have deployed some degree of search term conditioning to help correct typographical or other textual errors in the user's inputted search terms. Those corrective measures may, as shown, include running the user's inputted search terms against a dictionary or language model to correct clear typographical or spelling errors, and present the user with an option to click or activate an updated search based on spell-corrected search terms.

While this type of spell checking may assist users in the continuity or efficiency of their search experience, users may still experience the frustration or inefficiency of incomplete or unsatisfactory search results when their inputted search terms may be spelled correctly, but are open-ended in nature or open to multiple interpretations. Thus, for example, a user who types in the word “apple” assuming one interpretation of the term may be presented with a list of Web pages or other search results for various types of fruit or food vendors, with results related to New York City, with results related to a commercial computer company or other diverse potential hits or content. Available search services in those and other cases may be unable to discriminate between potentially useful or relevant responses and those which literally match the query, yet are not helpful to the user's search goals. This may be in one regard because those engines rely only upon the literal spelling and other content of the search terms themselves, and no other context for correction or refinement. Other problems and shortcomings in search technology exist.

### SUMMARY OF THE INVENTION

The invention overcoming these and other problems in the art relates in one regard to a system and method for generating alternative search terms, in which a set of search inputs may be received and parsed to generate suggested alternative searches not based merely on internal spell checking, but upon a suite of alternative search logic which examines a range of factors including both the user inputted search terms as well as the ensuing search results, and historical usage patterns for the same or similar search content. According to embodiments of the invention in one regard, the alternative search logic may be hosted in a search service or engine or otherwise, and perform any one or more of a series of analytic checks to generate suggested alternative search terms which the user may click or otherwise activate. That set of alternative search logic or analyses may include, in embodiments, a reverse query lookup against Web sites appearing as results to the user's initial search terms, to determine other search strings which have led to the same Web or other hits. That logic may include alternatives likewise based upon or derived from other historical or aggregate usage patterns, such as extracting alternative search terms based on expressed user satisfaction ratings on prior search results, or based on prior selected search extensions or refinement paths chosen by users selecting from similar alternative search term sets. Other usage-based and non-usage based logic or factors may be used, independently or in combination. According to embodiments of the invention, users may therefore be presented with alternative search possibilities, extensions or refinements that have a high likelihood of generating useful results for a user interested in the original set of search terms and/or search results.

### BRIEF DESCRIPTION OF THE DRAWINGS

FIG. 1 illustrates a search correction mechanism, according to known technology.

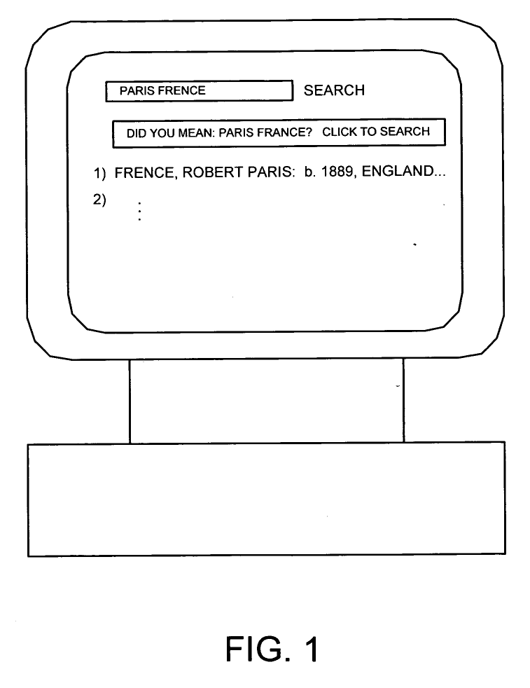

FIG. 2 illustrates a set of alternative search terms which may be generated according to embodiments of the invention.

FIG. 3 illustrates a set of alternative search logic, according to embodiments of the invention.

FIG. 4 illustrates a flowchart of overall search refinement processing, according to embodiments of the invention.

### DETAILED DESCRIPTION OF EMBODIMENTS

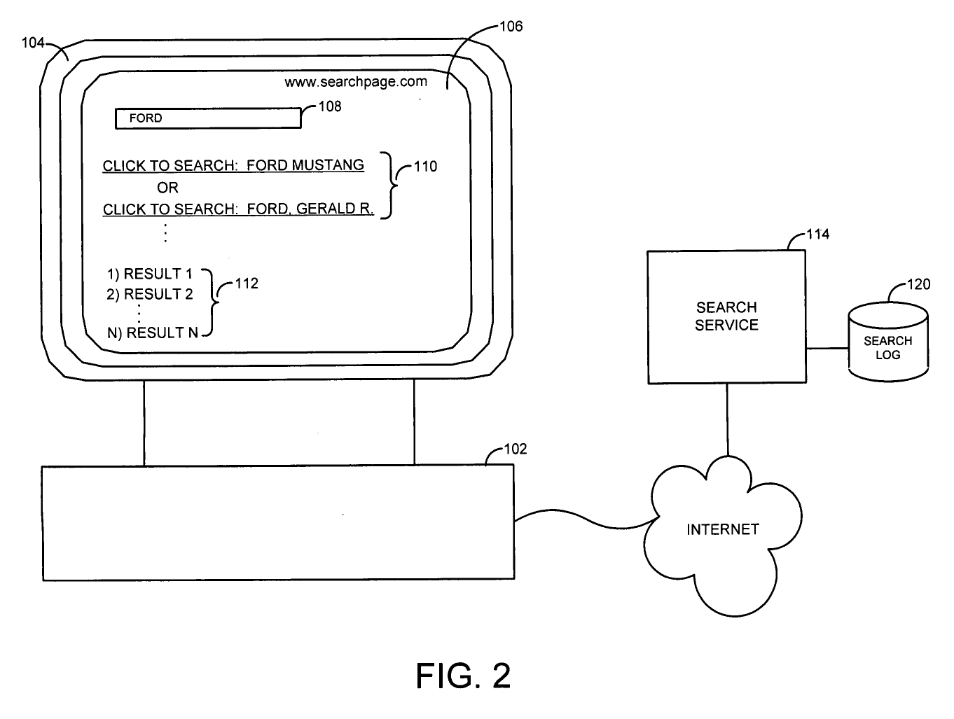

FIG. 2 illustrates an architecture in which a system and method for generating alternative search terms may operate, according to embodiments of the invention. As illustrated in that figure, a user may operate a client 102 such as a computer, personal digital assistant, network-enabled cellular telephone, or other client or device to enter search input and view search results. According to embodiments, the search activity may be conducted via a user interface 104 such as a graphical user interface, command-line interface, voice-activated or other interface or facility. According to embodiments of the invention in one regard, the user may navigate to a search page 106 to input search input 108 and perform those search activities, such as a publicly accessible search service 114, or other Web-based or other search engine or search resource accessed through online or networked media. In further embodiments search input 108 may be inputted via a desktop search tool or other application or offline media, for instance to search on local hard disk or other storage. The search input 108 may in any case consist of or contain a variety of information including typed-in words, numbers or other alphanumeric or other data or fields, in general reflecting topics or content of interest to the user and which the user wishes to use to locate Web sites, hard disk files or other content matching those search goals.

According to embodiments of the invention in one regard, the search service 114 or other search engine may receive the user's inputted search terms 108, and execute a search against a Web or other index or other content source to generate a set of initial search results 112, to present to the user for instance via user interface 104 in clickable, highlighted, or otherwise selectable or activatable form. For instance the user may activate a URL (universal resource locator) or other link or address in the set of initial search results 112 to navigate to a Web page or local file that may contain content of interest. However, according to embodiments of the invention in one regard, before, during or after the generation and presentation of the set of initial search results 112, the user may also be presented with a set of alternative search terms 110 which the user may click, select or activate to modify or refine their search. In general, the set of alternative search terms 110 may present a set of modified keywords or other search terms which search logic has determined may be likely to satisfy the user's search intent in relation to the user's query terms and/or the set of search results presented to the user. According to embodiments of the invention in another regard, and also in general, the set of alternative search terms 110 may be derived or generated from not simply the set of search input 108 such as to examine that string for spell checking, but from a variety of sources or intelligence or logic. Those sources may include the original search input 108 as well as the set of initial search results 112, and in addition stored or historical user search behavior on an individual user or aggregate level. That individual or aggregate usage data may for instance be stored in a search log 120 maintained by or sourced from search service 114. The search log 120 may contain, for example, aggregate search logs reflecting the collective search behavior of groups of users of that service, instrumented search logs or other feedback or data. It may be noted that according to embodiments of the invention in another regard, no individual user identification may be necessary to generate search refinements for a given user's query.

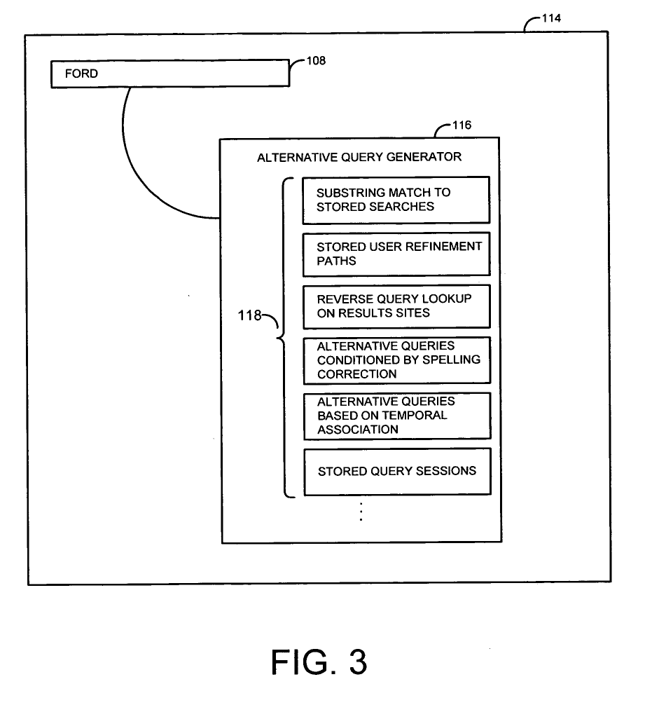

Thus and as more particularly illustrated in FIG. 3, for example, the search service 114 or other resource or site may host, access or initiate an alternative query generator 116 which applies a set of alternative search logic 118 to the search input, to generate the set of alternative search terms 110 to present to the user, or transmit to other destinations. The alternative search logic 118 may contain a group of logical engines, modules or processes which examine multiple inputs related to the search input 108, and generate the set of alternative search terms 110 designed to have an increased probability of satisfying the user's search intent or goals. Thus for example, the alternative search logic 118 may contain an engine, module or process to execute a substring or other match of search input 108 against a set of stored searches stored in search log 120, or otherwise. The stored searches may include user satisfaction ratings derived from prior users, for example, who have searched on the same or similar terms as the search input 108 and consequently rated or ranked their satisfaction with the ensuing Web site or other results. According to embodiments of the invention, that user satisfaction may be received in the form of explicit feedback from prior search users, for instance by popup, Web form or email query asking for satisfaction ratings. According to embodiments of the invention in another regard, the user ratings may be implicitly derived through other techniques, such as measuring the frequency of user click-throughs or activations of Web sites or other hits when presented as part of the results of prior searches. In an even more general case, the user ratings may be implicitly derived solely on the basis of query or query term popularity. In any regard, those search terms which resulted in the highest or best ratings by users as reflected in search log 120 or otherwise may be included in the set of alternative search terms 110, to offer the current user or searcher the selectable option to refine or extend their search activity accordingly with those terms.

For example, the alternative search logic 118 may contain an engine, module or process to execute a substring search or other matching search on prior stored searches in search log 120 or otherwise, to extract those extended search terms associated with prior user search extensions or refinement paths. Those paths may include searching on extended or refine search terms selected or incorporate at the level or one, two, three or other iterations in the prior search activity and user path selections. Those paths may reflect the selections of an aggregate group of users, or in embodiments, those of the individual user supplying the search input 108 in the current search session. Those paths may in embodiments furthermore be conditioned on the relatedness in time of the stored search refinement pairs, so that, for instance, only an original search and subsequent selection or refinement made within 5 minutes or other period of each other may be used. The resulting terms may then be presented as or as part of the set of alternative search terms 110. The alternative search logic 118 may contain an engine, module or process to execute a reverse query lookup to extract prior search or query terms which have generated the same Web sites or other hits or results, as the set of initial search results 112. Those terms may likewise be presented as or as part of the set of alternative search terms 110.

The alternative search logic 118 may similarly contain an engine, module or process to generate an updated set of alternative search terms which have been processed by a spell check routine or facility, to correct potentially faulty entries in the set of alternative search terms 110 before they are presented to the user. The alternative search logic 118 may then present the spell-corrected set of terms to the user as or as part of the set of alternative search terms 110, proper.

The alternative search logic 118 may further contain an engine, module or process to generate terms within the set of alternative search terms which may be associated with other search expressions on a temporal basis. That is, according to embodiments of the invention, the search log 120 or other analytic stores or sources may determine that a spike, change or upsurge in the frequency of one set of search terms, such as “federal tax forms”, with another set of terms, such as “April 15^{th}”, which indicate that users may be logically associating the content or results of those expressions. According to embodiments of the invention, the strength of that association may be dependent on the window of time, or closeness in time at which the tandem expressions are received. Search terms which are found to be linked, for instance using statistical engines or analytics indicating a non-random correlation, may be presented to the user as or as part of the set of alternative search terms 110, as well. The alternative search logic 118 may further store or contain a set of stored query sessions for an individual user, or group of users, to condition the terms to be generated in the set of alternative search terms 110 on prior usage data or historical user behavior, or use with other selection logic. In embodiments of the invention in another regard, any one or more logical engine, module or process accessed, hosted or initiated by the alternative search logic 118 may be applied independently, one after the other, in a nested or repeated fashion, or in other orders or sequences. For instance in embodiments of the invention in one regard, the analytic tests or logic performed by alternative search logic 118 may be serially executed on a conditional basis, so that for example if a spelling check confirms that a matching query was misspelled, that query may be discarded. Other conditional sequences are possible. The alternative search logic 118 may likewise in embodiments be extensible or editable, by operators of search service 114 or otherwise.

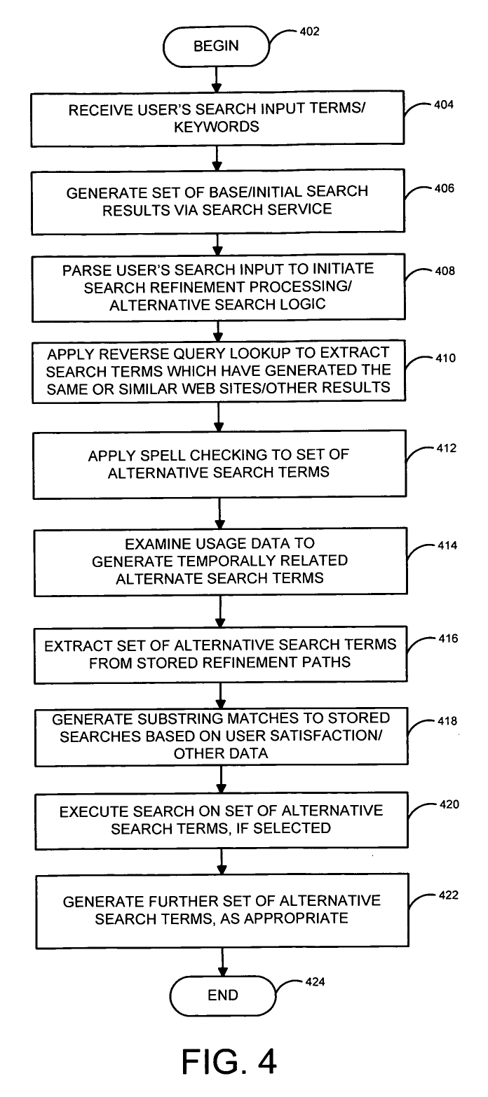

FIG. 4 illustrates overall search refinement processing, according to embodiments of the invention. In step 402, processing may begin. In step 404, search input 108 such as a word, set of words or other text string or other data may be received in search service 114 from a user or other source. In step 406, a base or set of initial search results 112 may be generated. In step 408, the search input 108 may be parsed or initiate query refinement processing, using alternative search logic 118 or other analytics or logic. (In embodiments, it may be noted that the alternative search logic 118 or other logic or control may in cases determine that alternative search refinement is not necessary or would not significantly enhance the search results, and therefore forego processing of potential refinements). In step 410, the alternative query generator 116 or other engine or logic may apply techniques in alternative search logic 118, such as for example to apply a reverse query lookup to extract previous queries, from search log 120 or otherwise, whose resulting Web sites or other hits or results match those reflected in set of initial search results 112. Those previous queries, or combinations of search terms thereof, may be presented as one or more of the set of alternative search terms 110. In step 412, further or other alternative search logic 118 may be applied to the search input 108 and/or the set of initial search results 112, for example to apply spell checking to the set of alternative search terms 110 to refine or correct those terms, themselves, before presentation to the user or in the results. In embodiments that spell checking may be performed before the set of alternative search terms 110 are presented to the users.

In step 414, further or other alternative search logic 118 may be applied to the search input 108 and/or the set of initial search results 112, for example to examine or analyze search log 120 or other usage data to detect or infer a temporal association or contemporaneous relationship between different search terms. For example it may be detected, using statistical engines or other inference engines, that a spike in the appearance of terms “Summer 2004 Olympics” corresponds with the appearance of the terms “Athens Greece”, in a certain time frame. According to embodiments of the invention, the temporally-related terms may then be presented as one or more of the set of alternative search terms 110. In step 416, further or other alternative search logic 118 may be applied to the search input 108 and/or the set of initial search results 112, for example to identify prior search extensions or refinement paths chosen by users inputting the same or similar search input 108, for instance by examining search log 120 or other data stores. The search terms reflected in those prior search extensions or refinement paths, which may include for instance a history of prior sets of alternative search terms 110 which have been clicked or selected by users in the past based on the same search inputs 108, may then be presented to the current user as one or more in the set of alternative search terms 110 for their search.

In step 418, further or other alternative search logic 118 may be applied to the search input 108 and/or the set of initial search results 112, for example to generate substring matches to other stored searches stored in search log 120 or otherwise to detect previous stored searches generating high user satisfaction feedback or other rating data. According to embodiments of the invention in this regard, substrings or additional terms whose results users have previously rated as generating satisfactory results may be included as one or more of the set of alternative search terms 110 which may be presented to the user. According to embodiments of the invention in one regard, that satisfaction rating may be derived from explicit feedback from users, such as by popup query, or from implicit accuracy ratings, such as those derived from percentage user click-through, or other selection or other user behavior data. Other accuracy or satisfaction ratings or rankings are possible.

In step 420, upon user selection of a suggested search in the set of alternative search terms 110, a search may be performed on that set of query refinements. In step 422, results from searching on the set of alternative search terms 110 may be presented, and a further set of alternative search terms 110 may be generated and presented. In embodiments, it may be noted that any of the alternative search logic 118 may be performed independently, or in a nested or repeated fashion, with different types or classes of refinement being applied in one or more sequence. In step 424, processing may repeat, return to a prior processing point, proceed to a further processing point or end.

The foregoing description of the invention is illustrative, and modifications in configuration and implementation will occur to persons skilled in the art. For instance, while the invention has generally been described in terms of a search service 114 apply alternative search logic 118 hosted in a single site or resource, in embodiments the alternative search logic 118 may be extensible and distributed amongst separate local or remote services, machines or resources.

Similarly, while the invention has in embodiments been described as illustratively operating on search input 108 received via a search service 114 which may be located on the Internet, in embodiments the search service 114 or other search engine or search logic may be located, accessed or hosted in other public or private network or other online resources. Moreover, while in embodiments the invention has been generally described as directly operating on the user's most recently inputted search terms 108, in embodiments the invention may operate across more than one query or query session generated by the user. In that regard, a prior input of the term “Toyota” may cause the alternative search logic 118 to select different, automobile-related terms for a subsequent entry of the term “Ford”, for example.

Further, in embodiments again the search logic or engine may for example be hosted in, and execute on client 102 itself, for instance to search the client machine's hard drive, optical or other storage on an offline or local basis. Other hardware, software or other resources described as singular may in embodiments be distributed, and similarly in embodiments resources described as distributed may be combined. Further, while the invention in embodiments has been generally been described as receiving the search input 108 from a user at client 102 or otherwise, in embodiments the search input 108 may be received from other automated, direct, indirect, stored, offline, batched or other sources. The scope of the invention is accordingly intended to be limited only by the following claims.

We claim:

1. A system for generating alternative search terms, comprising:
an input interface to receive a set of inputted search terms; and
alternative search logic, the alternative search logic communicating with the input interface to receive the inputted search terms and receiving a set of initial search results based on the inputted search terms, the alternative search logic generating a set of alternative search terms based on the inputted search terms and at least one of the initial search results and stored usage behavior.

2. A system according to claim 1, wherein the inputted search terms are received via at least one of offline media and online media.

3. A system according to claim 1, wherein the alternative search logic comprises at least one of analytic tests of—a reverse query lookup identifying searches resulting in at least one same result as the initial search results; a spell checking analysis performed on the alternative search terms; a temporal association between the inputted search terms and alternative search terms; identification of stored user-selected search extensions in matching prior searches; and identification of alternative search terms based on user-derived satisfaction ratings on matching prior searches.

4. A system according to claim 3, wherein the alternative search logic combines at least two of the analytic tests.

5. A system according to claim 3, wherein the analytic tests are serially executed on a conditional basis.

6. A system according to claim 1, wherein the alternative search terms are presented to the user in a selectable form.

7. A system according to claim 1, wherein the stored usage behavior comprises a search log stored by a search engine.

8. A method for generating alternative search terms, comprising:
receiving a set of inputted search terms;
receiving a set of initial search results based on the inputted search terms; and
generating a set of alternative search terms via alternative search logic based on the inputted search terms and at least one of the initial search results and stored usage behavior.

9. A method according to claim 8, wherein the receiving a set of inputted search terms comprises receiving the set of inputted search terms via at least one of offline media and online media.

10. A method according to claim 8, wherein the alternative search logic comprises at least one of analytic tests of—a reverse query lookup identifying searches resulting in at least one same result as the initial search results; a spell checking analysis performed on the alternative search terms; a temporal association between the inputted search terms and alternative search terms; identification of stored user-selected search extensions in matching prior searches; and identification of alternative search terms based on user-derived satisfaction ratings on matching prior searches.

11. A method according to claim 10, further comprising combining at least two of the analytic tests.

12. A method according to claim 10, further comprising serially executing the analytic tests on a conditional basis.

13. A method according to claim 8, further comprising presenting the alternative search terms to the user in a selectable form.

14. A method according to claim 8, wherein the stored usage behavior comprises a search log stored by a search engine.

15. A set of alternative search terms, the set of alternative search terms being generated by a method comprising:
receiving a set of inputted search terms;
receiving a set of initial search results based on the inputted search terms; and
generating a set of alternative search terms via alternative search logic based on the inputted search terms and at least one of the initial search results and stored usage behavior.

16. A set of alternative search terms according to claim 15, wherein the receiving a set of inputted search terms comprises receiving the set of inputted search terms via at least one of offline media and online media.

17. A set of alternative search terms according to claim 15, wherein the alternative search logic comprises at least one of analytic tests of—a reverse query lookup identifying searches resulting in at least one same result as the initial search results; a spell checking analysis performed on the alternative search terms; a temporal association between the inputted search terms and alternative search terms; identification of stored user-selected search extensions in matching prior searches; and identification of alternative search terms based on user-derived satisfaction ratings on matching prior searches.

18. A set of alternative search terms according to claim 17, wherein the method further comprises combining at least two of the analytic tests.

19. A set of alternative search terms according to claim 17, wherein the method further comprises serially executing the analytic tests on a conditional basis.

20. A set of alternative search terms according to claim 15, wherein the method further comprises presenting the alternative search terms to the user in a selectable form.
